(19) United States
(12) Patent Application Publication
(10) Pub. No.: US 2026/0066988 A1
(43) Pub. Date: Mar. 5, 2026

(54) TRAJECTORY-BASED LINE OF SIGHT PATH INSTRUCTIONS AND ROUND TRIP TIME CORRECTION

(71) Applicant: QUALCOMM Incorporated, San Diego, CA (US)

(72) Inventors: Pooria PAKROOH, San Marcos, CA (US); Bin TIAN, San Diego, CA (US); Stephen Jay SHELLHAMMER, Ramona, CA (US); Xiaoxin ZHANG, Sunnyvale, CA (US); Nisarg Keyurbhai TRIVEDI, Santa Clara, CA (US)

(21) Appl. No.: 18/821,243

(22) Filed: Aug. 30, 2024

(51) Int. Cl. H04B 10/112; H04B 10/079

(52) U.S. Cl. CPC H04B 10/112; H04B 10/0795

(57) ABSTRACT

Aspects of the disclosure are directed to LOS path instructions for a user of a UE. In a particular aspect, after detection of an NLOS path, the LOS path instructions provide guidance on how the user may move and/or reorient to (re)-establish a LOS path. In a particular aspect, the LOS path instructions are based on a trajectory of the UE over a period of time (e.g., by tracking the UE trajectory over a period of time which caused the LOS-to-NLOS path transition in the first place, the user can be guided back to the location where the LOS path was available). Further aspects of the disclosure are directed to round trip time (RTT) correction (e.g., based on a non-linear combination of multiple RTT measurements and/or an estimated displacement).

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a wireless node includes determining a non-line of sight (NLOS) path associated with a communications link of the wireless node; and transmitting or outputting a set of instructions to a user of the wireless node in response to the determination, the set of instructions configured to guide the user towards establishment or re-establishment of a line of sight (LOS) path for the communications link, wherein the set of instructions is based on trajectory information of the wireless node between a first time and a second time.

In an aspect, a method of operating a wireless node includes performing a set of round trip time (RTT) measurements of a set of radio frequency (RF) waveforms between the wireless node and another wireless node on a set of time instances within a time duration; and performing a non-linear combination of two or more RTT measurements from the set of RTT measurements based on a set of non-linear combination criteria to produce a processed subset of RTT measurements.

In an aspect, a method of operating a wireless node includes estimating a displacement of the wireless node between a first time and a second time based on one or more sensor measurements; performing a set of round trip time (RTT) measurements on a set of time instances within a time duration; and correcting one or more RTT measurements in the set of RTT measurements based on the estimated displacement.

In an aspect, a wireless node includes one or more memories; one or more transceivers; and one or more processors communicatively coupled to the one or more memories and the one or more transceivers, the one or more processors, either alone or in combination, configured to: determine a non-line of sight (NLOS) path associated with a communications link of the wireless node; and transmit, via the one or more transceivers, or output set of instructions to a user of the wireless node in response to the determination, the set of instructions configured to guide the user towards establishment or re-establishment of a line of sight (LOS) path for the communications link, wherein the set of instructions is based on trajectory information of the wireless node between a first time and a second time.

In an aspect, a wireless node includes one or more memories; one or more transceivers; and one or more processors communicatively coupled to the one or more memories and the one or more transceivers, the one or more processors, either alone or in combination, configured to: perform a set of round trip time (RTT) measurements of a set of radio frequency (RF) waveforms between the wireless node and another wireless node on a set of time instances within a time duration; and perform a non-linear combination of two or more RTT measurements from the set of RTT measurements based on a set of non-linear combination criteria to produce a processed subset of RTT measurements.

In an aspect, a wireless node includes one or more memories; one or more transceivers; and one or more processors communicatively coupled to the one or more memories and the one or more transceivers, the one or more processors, either alone or in combination, configured to: estimate a displacement of the wireless node between a first time and a second time based on one or more sensor measurements; perform a set of round trip time (RTT) measurements on a set of time instances within a time duration; and correct one or more RTT measurements in the set of RTT measurements based on the estimated displacement.

In an aspect, a wireless node includes means for determining a non-line of sight (NLOS) path associated with a communications link of the wireless node; and means for transmitting or outputting a set of instructions to a user of the wireless node in response to the determination, the set of instructions configured to guide the user towards establishment or re-establishment of a line of sight (LOS) path for the communications link, wherein the set of instructions is based on trajectory information of the wireless node between a first time and a second time.

In an aspect, a wireless node includes means for performing a set of round trip time (RTT) measurements of a set of radio frequency (RF) waveforms between the wireless node and another wireless node on a set of time instances within a time duration; and means for performing a non-linear combination of two or more RTT measurements from the set of RTT measurements based on a set of non-linear combination criteria to produce a processed subset of RTT measurements.

In an aspect, a wireless node includes means for estimating a displacement of the wireless node between a first time and a second time based on one or more sensor measurements; means for performing a set of round trip time (RTT) measurements on a set of time instances within a time duration; and means for correcting one or more RTT measurements in the set of RTT measurements based on the estimated displacement.

In an aspect, a non-transitory computer-readable medium storing computer-executable instructions that, when executed by a wireless node, cause the wireless node to: determine a non-line of sight (NLOS) path associated with a communications link of the wireless node; and transmit or output a set of instructions to a user of the wireless node in response to the determination, the set of instructions configured to guide the user towards establishment or re-establishment of a line of sight (LOS) path for the communications link, wherein the set of instructions is based on trajectory information of the wireless node between a first time and a second time.

In an aspect, a non-transitory computer-readable medium storing computer-executable instructions that, when executed by a wireless node, cause the wireless node to: perform a set of round trip time (RTT) measurements of a set of radio frequency (RF) waveforms between the wireless node and another wireless node on a set of time instances within a time duration; and perform a non-linear combination of two or more RTT measurements from the set of RTT measurements based on a set of non-linear combination criteria to produce a processed subset of RTT measurements.

In an aspect, a non-transitory computer-readable medium storing computer-executable instructions that, when executed by a wireless node, cause the wireless node to: estimate a displacement of the wireless node between a first time and a second time based on one or more sensor measurements; perform a set of round trip time (RTT) measurements on a set of time instances within a time duration; and correct one or more RTT measurements in the set of RTT measurements based on the estimated displacement.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIGS. 5A and 5B illustrate various scenarios of interest for sidelink-only or joint Uu and sidelink positioning, according to aspects of the disclosure.

FIG. 6 is a diagram illustrating an example round-trip-time (RTT) procedure for determining a location of a UE, according to aspects of the disclosure.

FIG. 7 is a diagram showing example timings of RTT measurement signals exchanged between a base station and a UE, according to aspects of the disclosure.

FIG. 8 is a diagram illustrating example timings of RTT measurement signals exchanged between a base station and a UE, according to aspects of the disclosure.

FIG. 9 is a diagram illustrating an example base station in communication with an example UE, according to aspects of the disclosure.

FIG. 10 illustrates an exemplary process of communications according to an aspect of the disclosure.

FIG. 11 illustrates an example implementation of the process of FIG. 10, in accordance with aspects of the disclosure.

FIG. 12 illustrates an exemplary process of communications according to an aspect of the disclosure.

FIG. 13 illustrates an exemplary process of communications according to an aspect of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to trajectory-based line of sight path instructions and round trip time (RTT) correction. In some designs, the user device does not have a corrective mechanism upon successful non-line of sight (NLOS) detection, e.g.: Since the user interface (UI) on user device depends on Wi-Fi information (e.g., Received Signal Strength Indicator (RSSI), RTT, etc.) it only has erroneous distance and direction information, user device does not know what trajectory corrections user should apply to solve NLOS, etc. Note that the same problem may occur for standard solutions to detect NLOS (e.g., channel impulse response (CIR) thresholding, channel frequency response (CFR) thresholding, channel state information (CSI) thresholding). Also, large errors in the ranging estimates can be observed due to NLOS situations, where the LOS path from the tag to the phone is blocked. In an aspect, range estimate is obtained from Round Trip Time (RTT) measurements of dedicated WiFi/UWB/BLE signals. In some designs, outlier range estimates are observed frequently. This is typically observed regardless of the Wireless technology used for range estimates, and mostly due to physical limitations of first arrival path estimation. Generally, inertial sensor measurements such as IMU and camera can provide reliable and accurate measurements of the phone's position, and its relative displacement.

Particular aspects of the subject matter described in this disclosure can be implemented to realize one or more of the following potential advantages. Aspects of the disclosure are directed to LOS path instructions for a user of a UE. In a particular aspect, after detection of a NLOS path, the LOS path instructions provide guidance on how the user may move and/or reorient to (re)-establish a LOS path. In a particular aspect, the LOS path instructions are based on a trajectory of the UE over a period of time (e.g., by tracking the UE trajectory over a period of time which caused the LOS-to-NLOS path transition in the first place, the user can be guided back to the location where the LOS path was available). Such aspects provide various technical advantages, such as more accurate position/ranging estimation, lower latency communications, reduced power consumption, and so on. Further aspects of the disclosure are directed to round trip time (RTT) correction (e.g., based on a non-linear combination of multiple RTT measurements and/or an estimated displacement). Such aspects may provide various technical advantages, such as improved ranging/positioning, reduced ranging/positioning latency, reduced power consumption, etc.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

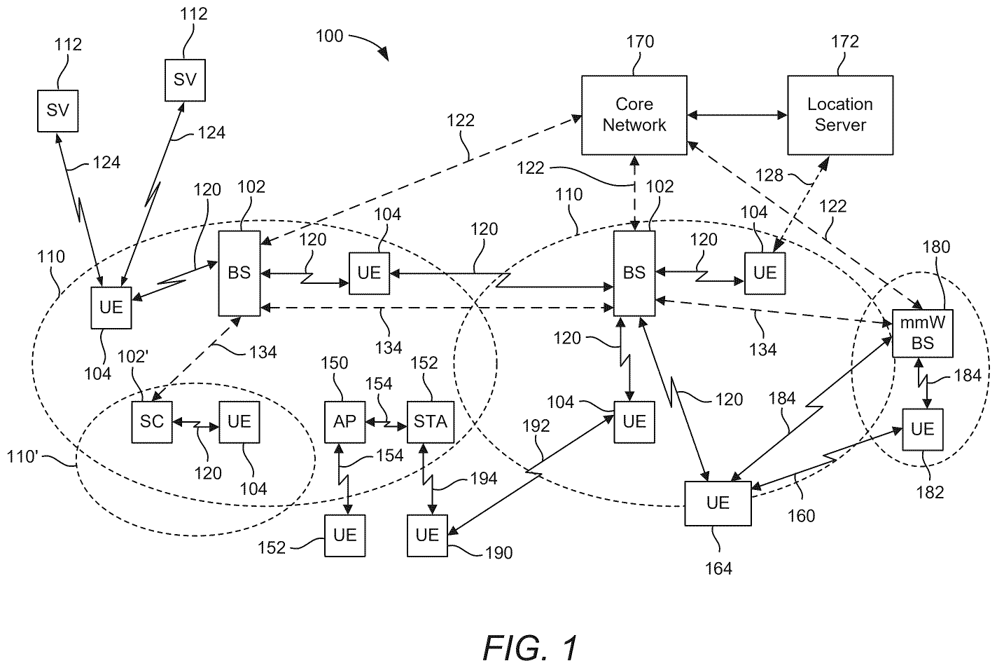

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz—7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

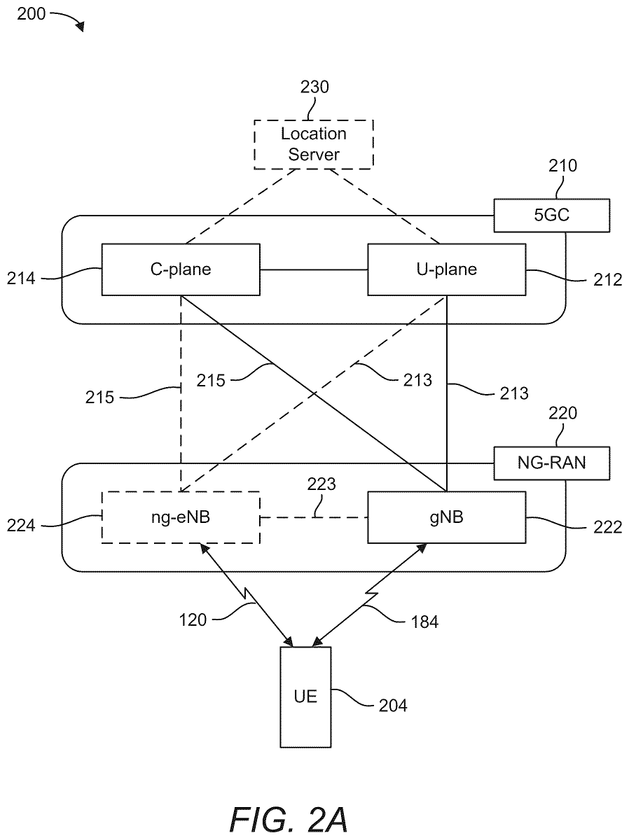

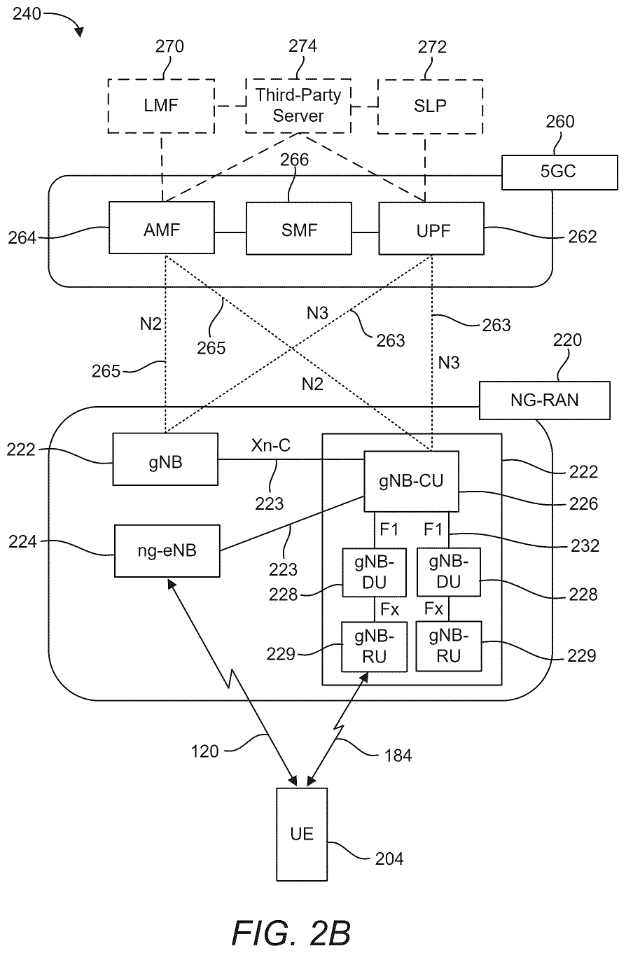

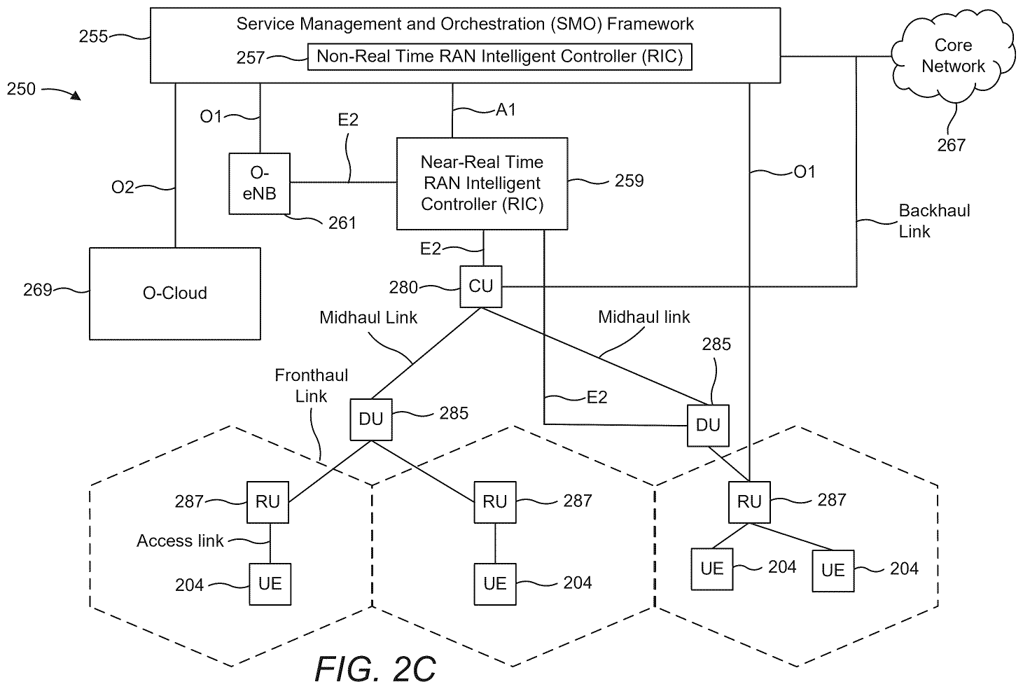

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit—User Plane (CU-UP)), control plane functionality (i.e., Central Unit—Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an AI interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as AI policies).

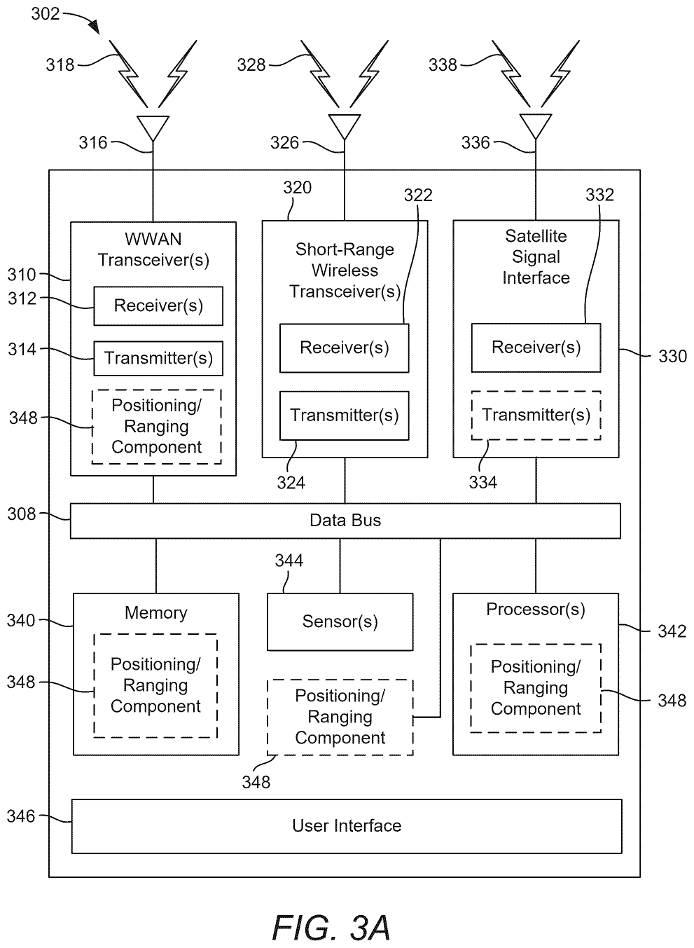

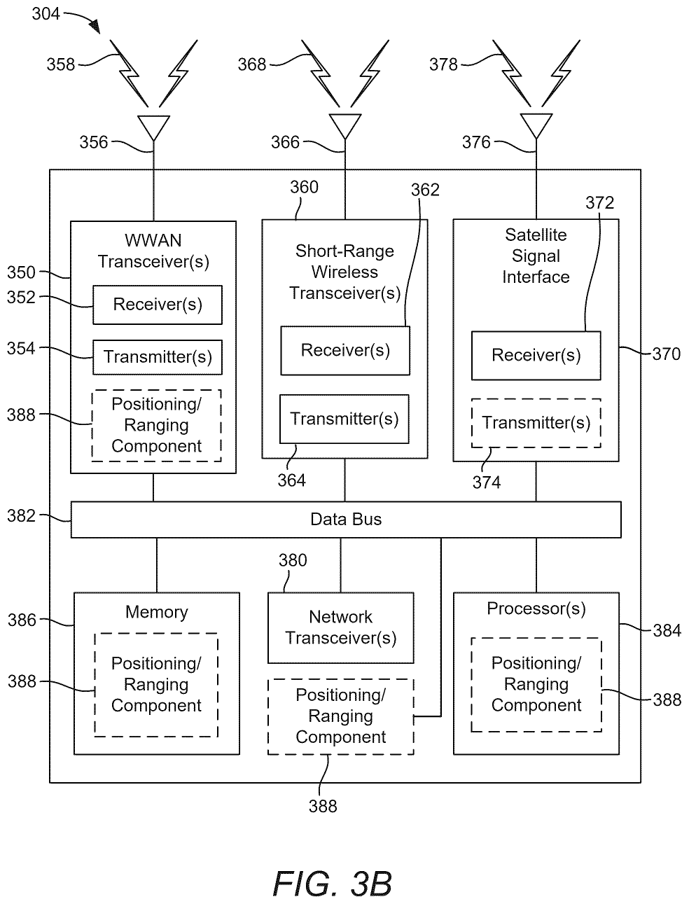

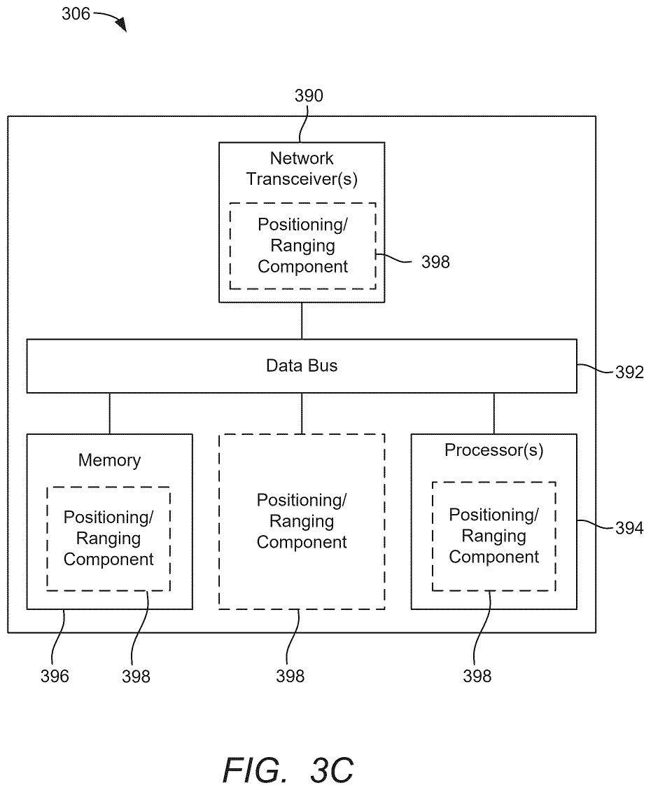

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning/ranging component 348, 388, and 398, respectively. The positioning/ranging component 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the positioning/ranging component 348, 388, and 398 may be external to the processors 342, 384, and 394 (e.g., part of a modem processing system, integrated with another processing system, etc.). Alternatively, the positioning/ranging component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning/ranging component 348, which may be, for example, part of the one or more WWAN transceivers 310, the memory 340, the one or more processors 342, or any combination thereof, or may be a standalone component. FIG. 3B illustrates possible locations of the positioning/ranging component 388, which may be, for example, part of the one or more WWAN transceivers 350, the memory 386, the one or more processors 384, or any combination thereof, or may be a standalone component. FIG. 3C illustrates possible locations of the positioning/ranging component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning/ranging component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

NR supports a number of cellular network-based positioning technologies, including downlink-based, uplink-based, and downlink-and-uplink-based positioning methods.

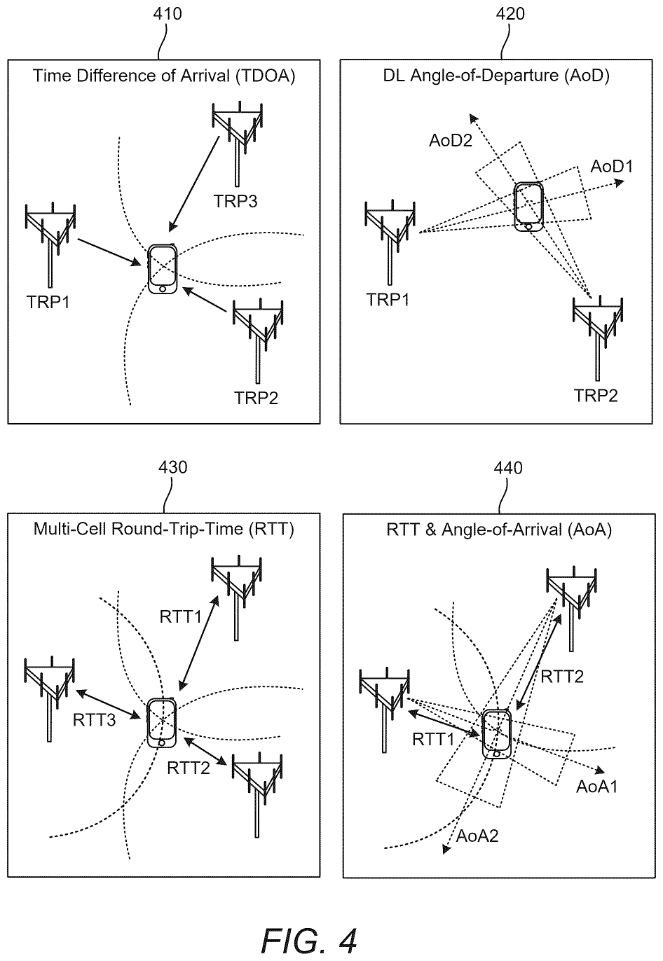

Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data. In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

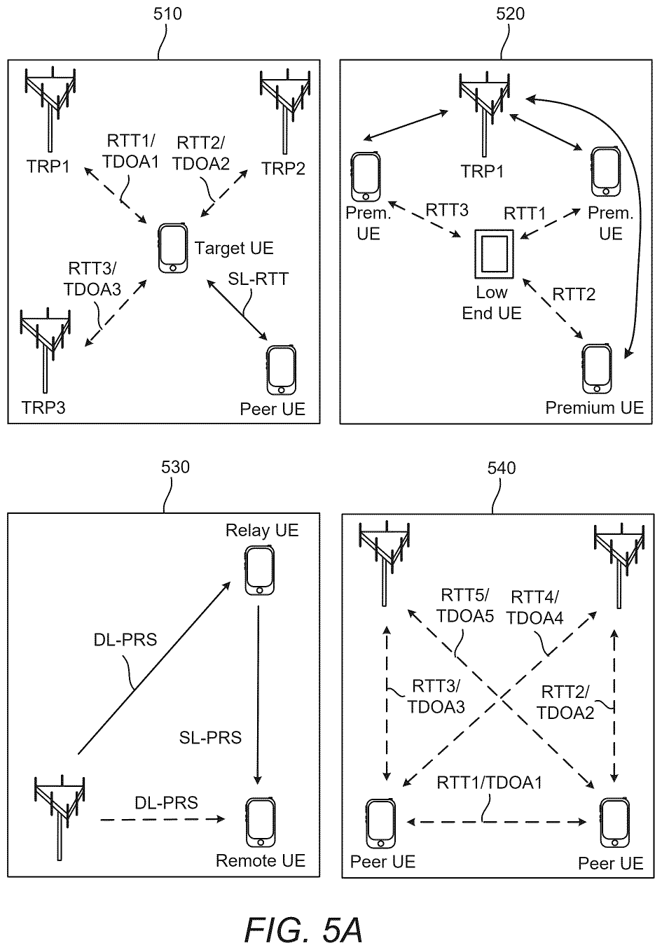

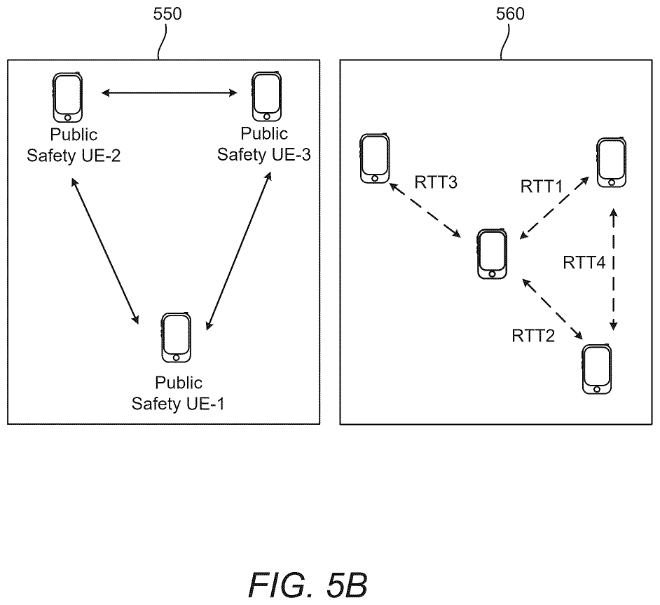

NR supports, or enables, various sidelink positioning techniques. FIG. 5A illustrates various scenarios of interest for sidelink-only or joint Uu and sidelink positioning, according to aspects of the disclosure. In scenario 510, at least one peer UE with a known location can improve the Uu-based positioning (e.g., multi-cell round-trip-time (RTT), downlink time difference of arrival (DL-TDOA), etc.) of a target UE by providing an additional anchor (e.g., using sidelink RTT (SL-RTT)). In scenario 520, a low-end (e.g., reduced capacity, or “RedCap”) target UE may obtain the assistance of premium UEs to determine its location using, e.g., sidelink positioning and ranging procedures with the premium UEs. Compared to the low-end UE, the premium UEs may have more capabilities, such as more sensors, a faster processor, more memory, more antenna elements, higher transmit power capability, access to additional frequency bands, or any combination thereof. In scenario 530, a relay UE (e.g., with a known location) participates in the positioning estimation of a remote UE without performing uplink positioning reference signal (PRS) transmission over the Uu interface. Scenario 540 illustrates the joint positioning of multiple UEs. Specifically, in scenario 540, two UEs with unknown positions can be jointly located in non-line-of-sight (NLOS) conditions by utilizing constraints from nearby UEs.

FIG. 5B illustrates additional scenarios of interest for sidelink-only or joint Uu and sidelink positioning, according to aspects of the disclosure. In scenario 550, UEs used for public safety (e.g., by police, firefighters, and/or the like) may perform peer-to-peer (P2P) positioning and ranging for public safety and other uses. For example, in scenario 550, the public safety UEs may be out of coverage of a network and determine a location or a relative distance and a relative position among the public safety UEs using sidelink positioning techniques. Similarly, scenario 560 shows multiple UEs that are out of coverage and determine a location or a relative distance and a relative position using sidelink positioning techniques, such as SL-RTT.

In NR, there may not be precise timing synchronization across the network. Instead, it may be sufficient to have coarse time-synchronization across base stations (e.g., within a cyclic prefix (CP) duration of the orthogonal frequency division multiplexing (OFDM) symbols). RTT-based methods generally only need coarse timing synchronization, and as such, are a preferred positioning method in NR.

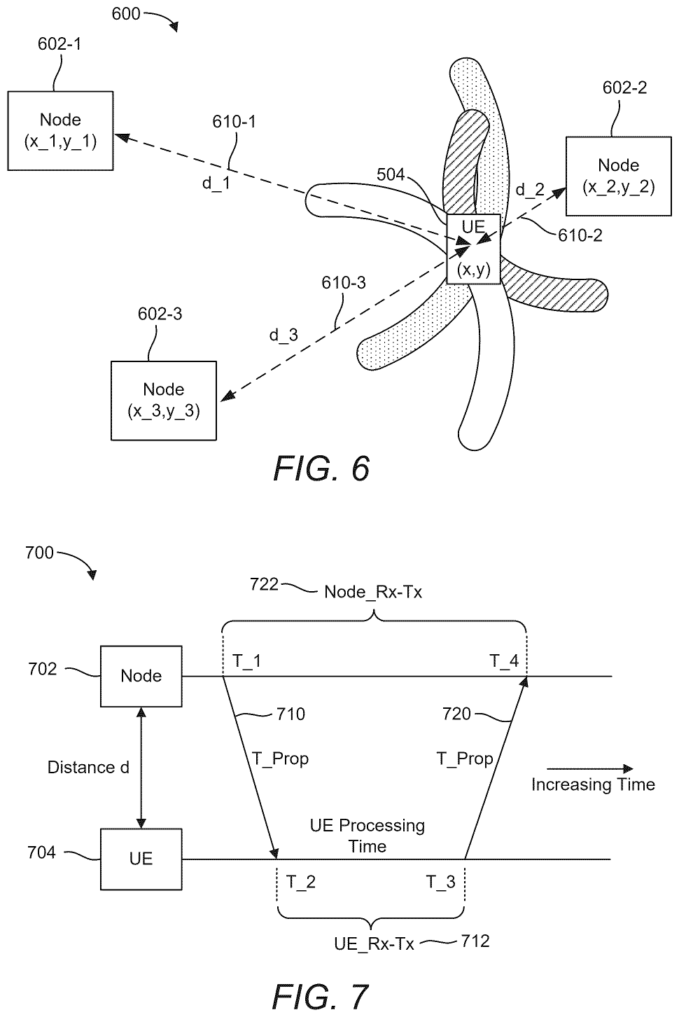

FIG. 6 illustrates an example wireless communications system 600, according to aspects of the disclosure. In the example of FIG. 6, a UE 604 (e.g., any of the UEs described herein) is attempting to calculate an estimate of its location, or assist another entity (e.g., a base station or core network component, another UE, a location server, a third party application, etc.) to calculate an estimate of its location. The UE 604 may transmit and receive wireless signals to and from a plurality of network nodes (labeled “Node”) 602-1, 602-2, and 602-3 (collectively, network nodes 602). The network nodes 602 may include one or more base stations (e.g., any of the base stations described herein), one or more reconfigurable intelligent displays (RIS), one or more positioning beacons, one or more UEs (e.g., connected over sidelinks), etc.

In a network-centric RTT positioning procedure the serving base station (e.g., one of network nodes 602) instructs the UE 604 to measure RTT measurement signals (e.g., PRS) from two or more neighboring network nodes 602 (and typically the serving base station, as at least three network nodes 602 are needed for a two-dimensional location estimate). The involved network nodes 602 transmit RTT measurement signals on low reuse resources (e.g., resources used by the network nodes 602 to transmit system information, where the network nodes 602 are base stations) allocated by the network (e.g., location server 230, LMF 270, SLP 272). The UE 604 records the arrival time (also referred to as the receive time, reception time, time of reception, or time of arrival) of each RTT measurement signal relative to the UE's 604 current downlink timing (e.g., as derived by the UE 604 from a downlink signal received from its serving base station), and transmits a common or individual RTT response signal (e.g., SRS) to the involved network nodes 602 on resources allocated by its serving base station. The UE 604, if it not the positioning entity, reports a UE reception-to-transmission (Rx-Tx) time difference measurement to the positioning entity. The UE Rx-Tx time difference measurement indicates the time difference between the arrival time of each RTT measurement signal at the UE 604 and the transmission time(s) of the RTT response signal(s). Each involved network node 602 also reports, to the positioning entity, a network node Rx-Tx time difference measurement (also referred to as a base station (BS) or gNB Rx-Tx time difference measurement), which indicates the difference between the transmission time of the RTT measurement signal and the reception time of the RTT response signal.

A UE-centric RTT positioning procedure is similar to the network-based procedure, except that the UE 604 transmits uplink RTT measurement signal(s) (e.g., on resources allocated by the serving base station). The uplink RTT measurement signal(s) are measured by multiple network nodes 602 in the neighborhood of the UE 604. Each involved network node 602 responds with a downlink RTT response signal and reports a network node Rx-Tx time difference measurement to the positioning entity. The network node Rx-Tx time difference measurement indicates the time difference between the arrival time of the RTT measurement signal at the network node 602 and the transmission time of the RTT response signal. The UE 604, if it is not the positioning entity, reports, for each network node 602, a UE Rx-Tx time difference measurement that indicates the difference between the transmission time of the RTT measurement signal and the reception time of the RTT response signal.

In order to determine the location (x, y) of the UE 604, the positioning entity needs to know the locations of the network nodes 602, which may be represented in a reference coordinate system as (x_k, y_y), where k=1, 2, 3 in the example of FIG. 6. Where the UE 604 is the positioning entity, a location server with knowledge of the network geometry (e.g., location server 230, LMF 270, SLP 272) may provide the locations of the involved network nodes 602 to the UE 604.

The positioning entity determines each distance 610 (d_k, where k=1, 2, 3) between the UE 604 and the respective network node 602 based on the UE Rx-Tx and network node Rx-Tx time difference measurements and the speed of light, as described further below with reference to FIG. 7. Specifically, in the example of FIG. 6, the distance 610-1 between the UE 604 and the network node 602-1 is d_1, the distance 610-2 between the UE 604 and the network node 602-2 is d_2, and the distance 610-3 between the UE 604 and the network node 602-3 is d_3. Once each distance 610 is determined, the positioning entity can solve for the location (x, y) of the UE 604 by using a variety of known geometric techniques, such as trilateration. From FIG. 6, it can be seen that the location of the UE 604 ideally lies at the common intersection of three semicircles, each semicircle being defined by radius dk and center (x_k, y_k), where k=1, 2, 3.

FIG. 7 is a diagram 700 showing example timings of RTT measurement signals exchanged between a network node 702 (labeled “Node”) and a UE 704, according to aspects of the disclosure. The UE 704 may be any of the UEs described herein. The network node 702 may be a base station (e.g., any of the base stations described herein), an RIS, a positioning beacon, another UE (e.g., connected over a sidelink), or the like.

In the example of FIG. 7, the network node 702 (labeled “BS”) sends an RTT measurement signal 710 (e.g., PRS) to the UE 704 at time T_1. The RTT measurement signal 710 has some propagation delay T_Prop as it travels from the network node 702 to the UE 704. At time T_2 (the reception time of the RTT measurement signal 710 at the UE 704), the UE 704 measures the RTT measurement signal 710. After some UE processing time, the UE 704 transmits an RTT response signal 720 (e.g., SRS) at time T_3. After the propagation delay T_Prop, the network node 702 measures the RTT response signal 720 from the UE 704 at time T_4 (the reception time of the RTT response signal 720 at the network node 702).

The UE 704 reports the difference between time T_3 and time T_2 (i.e., the UE's 704 Rx-Tx time difference measurement, shown as UE_Rx-Tx 712) to the positioning entity. Similarly, the network node 702 reports the difference between time T_4 and time T_1 (i.e., the network node's 702 Rx-Tx time difference measurement, shown as Node_Rx-Tx 722) to the positioning entity. Using these measurements and the known speed of light, the positioning entity can calculate the distance to the UE 704 as d=1/2*c*(Node_Rx-Tx−UE_Rx-Tx)=1/2*c*(T_4−T_1)−1/2*c*(T_3−T_2), where c is the speed of light.

Based on the known location of the network node 702 and the distance between the UE 704 and the network node 702 (and at least two other network nodes 702), the positioning entity can calculate the location of the UE 704. As shown in FIG. 6, the location of the UE 704 lies at the common intersection of three semicircles, each semicircle being defined by a radius of the distance between the UE 704 and a respective network node 702.

In an aspect, the positioning entity may calculate the UE's 604/704 location using a two-dimensional coordinate system; however, the aspects disclosed herein are not so limited, and may also be applicable to determining locations using a three-dimensional coordinate system, if the extra dimension is desired. Additionally, while FIG. 6 illustrates one UE 604 and three network nodes 602 and FIG. 7 illustrates one UE 704 and one network node 702, as will be appreciated, there may be more UEs 604/704 and more network nodes 602/702.

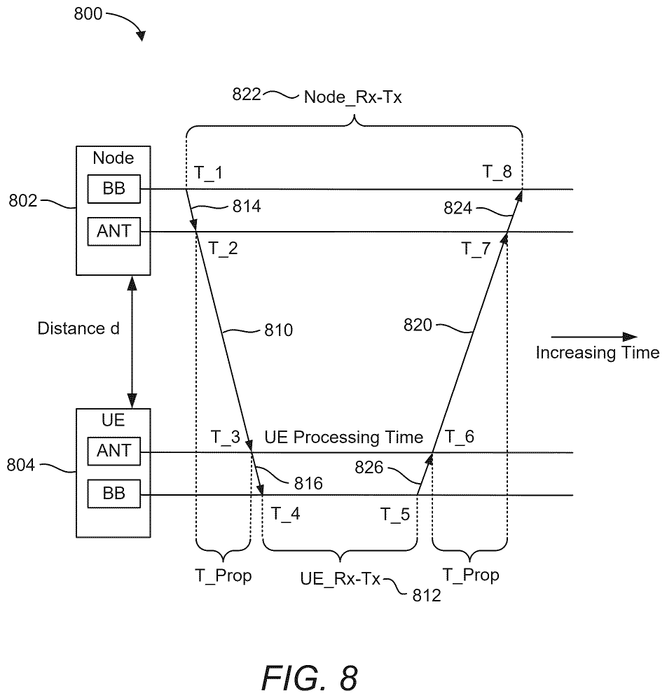

FIG. 8 is a diagram 800 showing example timings of RTT measurement signals exchanged between a network node 802 and a UE 804, according to aspects of the disclosure. The diagram 800 is similar to the diagram 700, except that it includes processing delays that may occur at both the network node 802 (labeled “Node”) and the UE 804 when transmitting and receiving the RTT measurement and response signals. The network node 802 may be a base station (e.g., any of the base stations), an RIS (e.g., RIS 410), another UE (e.g., any of the UEs described herein), or other network node capable of performing an RTT positioning procedure. As a specific example, the network node 802 and the UE 804 may correspond to the base station 702 and the UE 704 in FIG. 7.

Referring now to potential processing delays, at the network node 802, there is a transmission delay 814 between the time T_1 that the network node's 802 baseband (labeled “BB”) generates the RTT measurement signal 810 (e.g., a PRS) and the time T_2 that the network node's 802 antenna(s) (labeled “Ant”) transmit the RTT measurement signal 810. At the UE 804, there is a reception delay 816 between the time T_3 that the UE's 604 antenna(s) (labeled “Ant”) receive the RTT measurement signal 810 and the time T_4 that the UE's 804 baseband (labeled “BB”) processes the RTT measurement signal 810.

Similarly, for the RTT response signal 820 (e.g., an SRS), there is a transmission delay 826 between the time T_5 that the UE's 804 baseband generates the RTT response signal 820 and the time T_6 that the UE's 804 antenna(s) transmit the RTT response signal 820. At the network node 802, there is a reception delay 824 between the time T_7 that the network node's 802 antenna(s) receive the RTT response signal 820 and the time T_8 that the network node's 802 baseband processes the RTT response signal 820.

The difference between times T_2 and T_1 (i.e., transmission delay 814) and times T_8 and T_7 (i.e., reception delay 824) is referred to as the network node's 802 “group delay.” The difference between times T_4 and T_3 (i.e., reception delay 816) and times T_6 and T_5 (i.e., transmission delay 826) is referred to as the UE's 804 “group delay.” The group delay includes a hardware group delay, a group delay attributable to software/firmware, or both. More specifically, although software and/or firmware may contribute to group delay, the group delay is primarily due to internal hardware delays between the baseband and the antenna(s) of the network node 802 and the UE 804.

As shown in FIG. 8, because of the reception delay 816 and the transmission delay 826, the UE's 804 Rx-Tx time difference measurement 812 does not represent the difference between the actual reception time at time T_3 and the actual transmission time at time T_6. Similarly, because of the transmission delay 814 and the reception delay 824, the network node's 802 Rx-Tx time difference measurement 822 does not represent the difference between the actual transmission time at time T_2 and the actual reception time at time T_7. Thus, as shown, group delays, such as reception delays 816 and 824 and transmission delays 814 and 826, can contribute to timing errors and/or calibration errors that can impact RTT measurements, as well as other measurements, such as TDOA, RSTD, etc. This can in turn can impact positioning performance. For example, in some designs, a 10 ns error will introduce three meters of error in the final location estimate.

In some cases, the UE 804 can calibrate its group delay and compensate for it so that the UE Rx-Tx time difference measurement 812 reflects the actual reception and transmission times from its antenna(s). Alternatively, the UE 804 can report its group delay to the positioning entity (if not the UE 804), which can then subtract the group delay from the UE Rx-Tx time difference measurement 812 when determining the final distance between the network node 802 and the UE 804. Similarly, the network node 802 may be able to compensate for its group delay in the network node Rx-Tx time difference measurement 822, or simply report the group delay to the positioning entity.

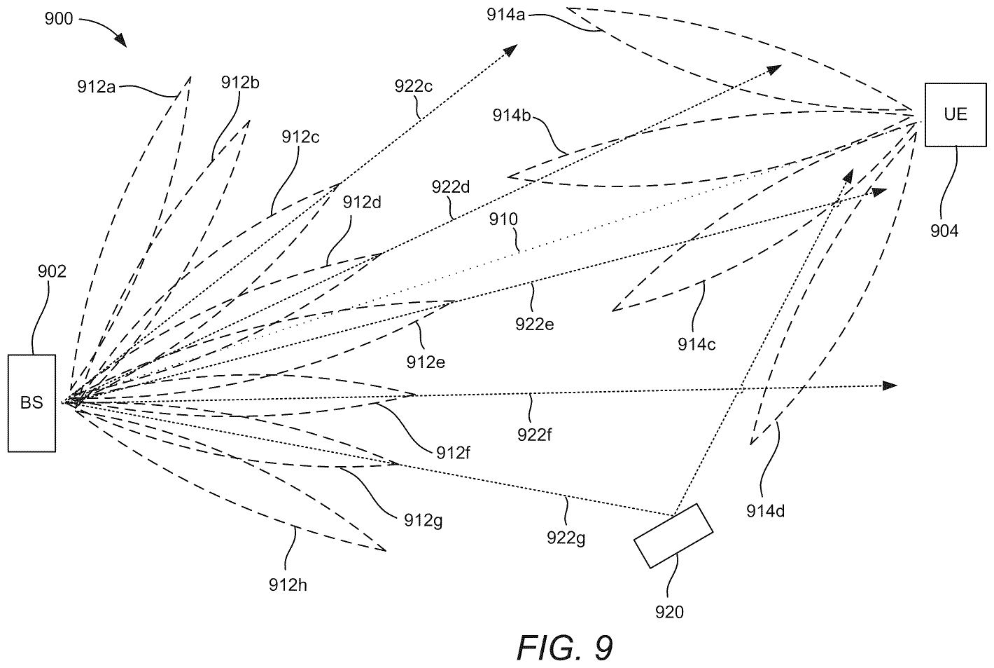

FIG. 9 is a diagram 900 illustrating a base station (BS) 902 (which may correspond to any of the base stations described herein) in communication with a UE 904 (which may correspond to any of the UEs described herein). Referring to FIG. 9, the base station 902 may transmit a beamformed signal to the UE 904 on one or more transmit beams 912a, 912b, 912c, 912d, 912e, 912f, 912g, 912h (collectively, beams 912), each having a beam identifier that can be used by the UE 904 to identify the respective beam. Where the base station 902 is beamforming towards the UE 904 with a single array of antennas (e.g., a single TRP/cell), the base station 902 may perform a “beam sweep” by transmitting first beam 912a, then beam 912b, and so on until lastly transmitting beam 912h. Alternatively, the base station 902 may transmit beams 912 in some pattern, such as beam 912a, then beam 912h, then beam 912b, then beam 912g, and so on. Where the base station 902 is beamforming towards the UE 904 using multiple arrays of antennas (e.g., multiple TRPs/cells), each antenna array may perform a beam sweep of a subset of the beams 912. Alternatively, each of beams 912 may correspond to a single antenna or antenna array.

FIG. 9 further illustrates the paths 922c, 922d, 922e, 922f, and 922g followed by the beamformed signal transmitted on beams 912c, 912d, 912e, 912f, and 912g, respectively. Each path 922c, 922d, 922e, 922f, 922g may correspond to a single “multipath” or, due to the propagation characteristics of radio frequency (RF) signals through the environment, may be comprised of a plurality (a cluster) of “multipaths.” Note that although only the paths 922c-922g for beams 912c-912g are shown, this is for simplicity, and the signal transmitted on each of beams 912 will follow some path. In the example shown, the paths 922c, 922d, 922e, and 922f are straight lines, while path 922g reflects off an obstacle 920 (e.g., a building, vehicle, terrain feature, etc.).

The UE 904 may receive the beamformed signal from the base station 902 on one or more receive beams 914a, 914b, 914c, 914d (collectively, beams 914). Note that for simplicity, the beams illustrated in FIG. 9 represent either transmit beams or receive beams, depending on which of the base station 902 and the UE 904 is transmitting and which is receiving. Thus, the UE 904 may also transmit a beamformed signal to the base station 902 on one or more of the beams 914, and the base station 902 may receive the beamformed signal from the UE 904 on one or more of the beams 912.

In an aspect, the base station 902 and the UE 904 may perform beam training to align the transmit and receive beams of the base station 902 and the UE 904. For example, depending on environmental conditions and other factors, the base station 902 and the UE 904 may determine that the best transmit and receive beams are 912d and 914b, respectively, or beams 912e and 914c, respectively. The direction of the best transmit beam for the base station 902 may or may not be the same as the direction of the best receive beam, and likewise, the direction of the best receive beam for the UE 904 may or may not be the same as the direction of the best transmit beam. Note, however, that aligning the transmit and receive beams is not necessary to perform a downlink angle-of-departure (DL-AoD) or uplink angle-of-arrival (UL-AoA) positioning procedure.

To perform a DL-AoD positioning procedure, the base station 902 may transmit reference signals (e.g., PRS, CRS, TRS, CSI-RS, PSS, SSS, etc.) to the UE 904 on one or more of beams 912, with each beam having a different transmit angle. The different transmit angles of the beams will result in different received signal strengths (e.g., RSRP, RSRQ, SINR, etc.) at the UE 904. Specifically, the received signal strength will be lower for transmit beams 912 that are further from the line of sight (LOS) path 910 between the base station 902 and the UE 904 than for transmit beams 912 that are closer to the LOS path 910.

In the example of FIG. 9, if the base station 902 transmits reference signals to the UE 904 on beams 912c, 912d, 912e, 912f, and 912g, then transmit beam 912e is best aligned with the LOS path 910, while transmit beams 912c, 912d, 912f, and 912g are not. As such, beam 912e is likely to have a higher received signal strength at the UE 904 than beams 912c, 912d, 912f, and 912g. Note that the reference signals transmitted on some beams (e.g., beams 912c and/or 912f) may not reach the UE 904, or energy reaching the UE 904 from these beams may be so low that the energy may not be detectable or at least can be ignored.

The UE 904 can report the received signal strength, and optionally, the associated measurement quality, of each measured transmit beam 912c-912g to the base station 902, or alternatively, the identity of the transmit beam having the highest received signal strength (beam 912e in the example of FIG. 9). Alternatively or additionally, if the UE 904 is also engaged in a round-trip-time (RTT) or time-difference of arrival (TDOA) positioning session with at least one base station 902 or a plurality of base stations 902, respectively, the UE 904 can report reception-to-transmission (Rx-Tx) time difference or reference signal time difference (RSTD) measurements (and optionally the associated measurement qualities), respectively, to the serving base station 902 or other positioning entity. In any case, the positioning entity (e.g., the base station 902, a location server, a third-party client, UE 904, etc.) can estimate the angle from the base station 902 to the UE 904 as the AoD of the transmit beam having the highest received signal strength at the UE 904, here, transmit beam 912e.

In one aspect of DL-AoD-based positioning, where there is only one involved base station 902, the base station 902 and the UE 904 can perform a round-trip-time (RTT) procedure to determine the distance between the base station 902 and the UE 904. Thus, the positioning entity can determine both the direction to the UE 904 (using DL-AoD positioning) and the distance to the UE 904 (using RTT positioning) to estimate the location of the UE 904. Note that the AoD of the transmit beam having the highest received signal strength does not necessarily lie along the LOS path 910, as shown in FIG. 9. However, for DL-AoD-based positioning purposes, it is assumed to do so.

In another aspect of DL-AoD-based positioning, where there are multiple involved base stations 902, each involved base station 902 can report, to the serving base station 902, the determined AoD from the respective base station 902 to the UE 904, or the RSRP measurements. The serving base station 902 may then report the AoDs or RSRP measurements from the other involved base station(s) 912 to the positioning entity (e.g., UE 904 for UE-based positioning or a location server for UE-assisted positioning). With this information, and knowledge of the base stations' 902 geographic locations, the positioning entity can estimate a location of the UE 904 as the intersection of the determined AoDs. There should be at least two involved base stations 902 for a two-dimensional (2D) location solution, but as will be appreciated, the more base stations 902 that are involved in the positioning procedure, the more accurate the estimated location of the UE 904 will be.

To perform an UL-AoA positioning procedure, the UE 904 transmits uplink reference signals (e.g., UL-PRS, SRS, DMRS, etc.) to the base station 902 on one or more of uplink transmit beams 914. The base station 902 receives the uplink reference signals on one or more of uplink receive beams 912. The base station 902 determines the angle of the best receive beams 912 used to receive the one or more reference signals from the UE 904 as the AoA from the UE 904 to itself. Specifically, each of the receive beams 912 will result in a different received signal strength (e.g., RSRP, RSRQ, SINR, etc.) of the one or more reference signals at the base station 902. Further, the channel impulse response of the one or more reference signals will be smaller for receive beams 912 that are further from the actual LOS path 910 between the base station 902 and the UE 904 than for receive beams 912 that are closer to the LOS path 910. Likewise, the received signal strength will be lower for receive beams 912 that are further from the LOS path 910 than for receive beams 912 that are closer to the LOS path 910. As such, the base station 902 identifies the receive beam 912 that results in the highest received signal strength and, optionally, the strongest channel impulse response, and estimates the angle from itself to the UE 904 as the AoA of that receive beam 912. Note that as with DL-AoD-based positioning, the AoA of the receive beam 912 resulting in the highest received signal strength (and strongest channel impulse response if measured) does not necessarily lie along the LOS path 910. However, for UL-AoA-based positioning purposes in FR2, it may be assumed to do so.

Note that while the UE 904 is illustrated as being capable of beamforming, this is not necessary for DL-AoD and UL-AoA positioning procedures. Rather, the UE 904 may receive and transmit on an omni-directional antenna.

Where the UE 904 is estimating its location (i.e., the UE is the positioning entity), it needs to obtain the geographic location of the base station 902. The UE 904 may obtain the location from, for example, the base station 902 itself or a location server (e.g., location server 230, LMF 270, SLP 272). With the knowledge of the distance to the base station 902 (based on the RTT or timing advance), the angle between the base station 902 and the UE 904 (based on the UL-AoA of the best receive beam 912), and the known geographic location of the base station 902, the UE 904 can estimate its location.

Alternatively, where a positioning entity, such as the base station 902 or a location server, is estimating the location of the UE 904, the base station 902 reports the AoA of the receive beam 912 resulting in the highest received signal strength (and optionally strongest channel impulse response) of the reference signals received from the UE 904, or all received signal strengths and channel impulse responses for all receive beams 912 (which allows the positioning entity to determine the best receive beam 912). The base station 902 may additionally report the Rx-Tx time difference to the UE 904. The positioning entity can then estimate the location of the UE 904 based on the UE's 904 distance to the base station 902, the AoA of the identified receive beam 912, and the known geographic location of the base station 902.

Consider a Wi-Fi Tag use-case, where a tag emits Wi-Fi. A user-device searches for the tag based on distance and direction shown on device UI using RSSI, RTT, etc. information. Misleading user guidance and/or a higher tag-search time may occur due to Non-Line of Sight (NLOS), e.g.: User moves away from the Wi-Fi tag, user body blocking the direct line-of-sight b/w the tag and user device, UI shows inaccurate distance and/or direction calculated from RTT, misleading the user to wrong direction and distance, more time is spent to detect the tag due to erroneous guidance, etc. For various radio access technologies (RATs), in some designs, when using time-of-flight (TOF) to measure distance to a peer device, it is critical to accurately detect the direct path signal and estimate TOF based on the direct path signal. When the direct path signal is blocked (e.g., by human body), the direct path signal may be attenuated too much to cause TOF being estimated on a reflected path, causing error in the estimated distance.

In some designs, the user device does not have a corrective mechanism upon successful NLOS detection, e.g.: Since the UI on user device depends on Wi-Fi information (e.g., RSSI, RTT, etc.) it only has erroneous distance and direction information, user device does not know what trajectory corrections user should apply to solve NLOS, etc. Note that the same problem may occur for standard solutions to detect NLOS (e.g., CIR thresholding, channel frequency response (CFR) thresholding, channel state information (CSI) thresholding).

The above-noted NLOS path problems may occur in other RATs as well, such as UWB (e.g., Apple air tag), Bluetooth (e.g., Tile).

In one example, assume that a user's body blocks a LOS path while walking away from the Wi-Fi emitter (AP). In this case, the transition from LOS path to NLOS path (caused by the user body blockage) creates a sudden jump in RTT range estimate, after which there is a high ranging error for NLOS path.

Aspects of the disclosure are directed to LOS path instructions for a user of a UE. In a particular aspect, after detection of a NLOS path, the LOS path instructions provide guidance on how the user may move and/or reorient to (re)-establish a LOS path. In a particular aspect, the LOS path instructions are based on a trajectory of the UE over a period of time (e.g., by tracking the UE trajectory over a period of time which caused the LOS-to-NLOS path transition in the first place, the user can be guided back to the location where the LOS path was available). Such aspects provide various technical advantages, such as more accurate position/ranging estimation, lower latency communications, reduced power consumption, and so on.

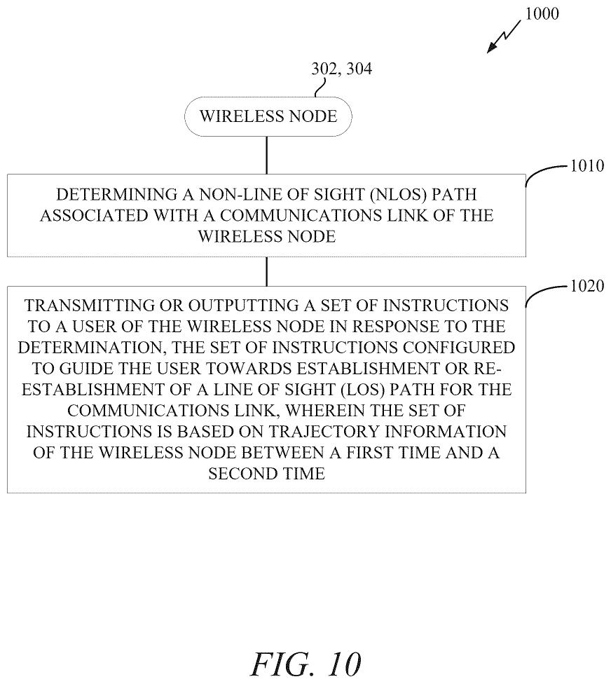

FIG. 10 illustrates an exemplary process 1000 of communications according to an aspect of the disclosure. The process 1000 of FIG. 10 is performed by a wireless node, such as UE 302 or a wireless network component such as gNB/BS 304 or O-RAN component such as RU.

Referring to FIG. 10, at 1010, the wireless node (e.g., processor(s) 342 or 384, positioning/ranging component 348 or 388, etc.) determines a non-line of sight (NLOS) path associated with a communications link of the wireless node. In some designs, a means for performing the determination of 1010 includes processor(s) 342 or 384, positioning/ranging component 348 or 388, etc., of FIGS. 3A-3B.

Referring to FIG. 10, at 1020, the wireless node (e.g., processor(s) 342 or 384, positioning/ranging component 348 or 388, transmitter 314 or 324 or 354 or 364, user interface 346, etc.) transmits or outputs a set of instructions to a user of the wireless node in response to the determination, the set of instructions configured to guide the user towards establishment or re-establishment of a line of sight (LOS) path for the communications link. In an aspect, the set of instructions is based on trajectory information of the wireless node between a first time and a second time (e.g., the first time may correspond to a time when the UE had last established the LOS path, and the second tie may correspond to a current time and/or a time when the UE is at its current location). In some designs, a means for performing the transmission of output of 1020 includes processor(s) 342 or 384, positioning/ranging component 348 or 388, transmitter 314 or 324 or 354 or 364, user interface 346, etc., of FIGS. 3A-3B.

Referring to FIG. 10, in some designs, the wireless node further derives a first round trip time (RTT) value associated with a first time based on a first set of RTT measurements, derives a second RTT value associated with a second time based on a second set of RTT measurements. In an aspect, the determination of the NLOS path associated with the communications link is based on the information associated with the first RTT value and the second RTT value. In some designs, the information includes first differential between a first received signal strength associated with the first set of RTT measurements and a second received signal strength associated with the second set of RTT measurements, or a second differential between a first ranging estimate based on the first RTT value and a second ranging estimate based on the second RTT value, or a combination thereof.

Referring to FIG. 10, in some designs, the wireless node further transmits or outputs an NLOS alert to the user of the wireless node in response to the determination.

Referring to FIG. 10, in some designs, the trajectory information is based on sensor-based tracking of movement associated with the wireless node by one or more sensors. In an aspect, the sensor-based tracking is continuous, intermittent, or movement-triggered. In an aspect, the sensor-based tracking is based on a battery level associated with the wireless node. In an aspect, the sensor-based tracking comprises six degrees of freedom (6DoF)-based tracking. In an aspect, the one or more sensors comprise a camera, a Global Navigation Satellite System (GNSS) sensor, an Inertial Measurement Unit (IMU) sensor, a Light Detection and Ranging (LiDAR) sensor, a Time of Flight (ToF) sensor, a radio ranging sensor using wireless or radio transmission, or any combination thereof.

Referring to FIG. 10, in a specific example, a NLOS may be detected with a confidence score. In an aspect, in addition to the power comparisons of Channel Impulse Response (c) with a threshold1 for detecting LOS path vs. NLOS path, NLOS path may also be detected based on a sudden jump in RTT range estimates (i.e., greater than some RTT change threshold2). In an aspect, the NLOS confidence score may be determined based on outputs of the two algorithms above, e.g., very high NLOS confidence score if both conditions match with large margins above thresholds.

Referring to FIG. 10, in a specific example, a user-sensor collaboration and correction mechanism upon successful NLOS detection may be implemented. In an aspect, a low-power IMU 6DoF tracker keeps track of user trajectory. Upon high confidence of NLOS path detection, the 6DoF tracker shows user trajectory that caused the NLOS path condition and take corrective measure(s) (e.g., the last left turn caused NLOS path, turn right to recover LOS path).

Referring to FIG. 10, in a specific example, a self-correct DoF tracker from user action may be implemented. For example, the user is prompted to move (e.g., turn right 90 degrees). In an aspect, IMU detects when (or if) user follows the instruction. In an aspect, this is known as a motion measurement to self-correct the 6DoF tracker reducing accumulated errors and reliable long term system functioning.

Referring to FIG. 10, in a specific example, there is a time efficiency benefit with correct UI guidance on user-device. In an aspect, the user device UI is updated to show user's trajectory, NLOS alert and corrective action. In an aspect, this may result in quicker tag discovery.

Referring to FIG. 10, in a specific example, an adaptive threshold update for the user environment may be utilized. In an aspect, every time a tracker is found, the algorithm analyzes last few minutes of tag-tracker output (RTT, RSSI, CIR, CFR, CSI, etc.) as well as associated 6DoF trajectory. In an aspect, one or more of the thresholds are updated for LOS paths leading to successful tag discovery, adapting to Wi-Fi interference and channel reflection in given environment.

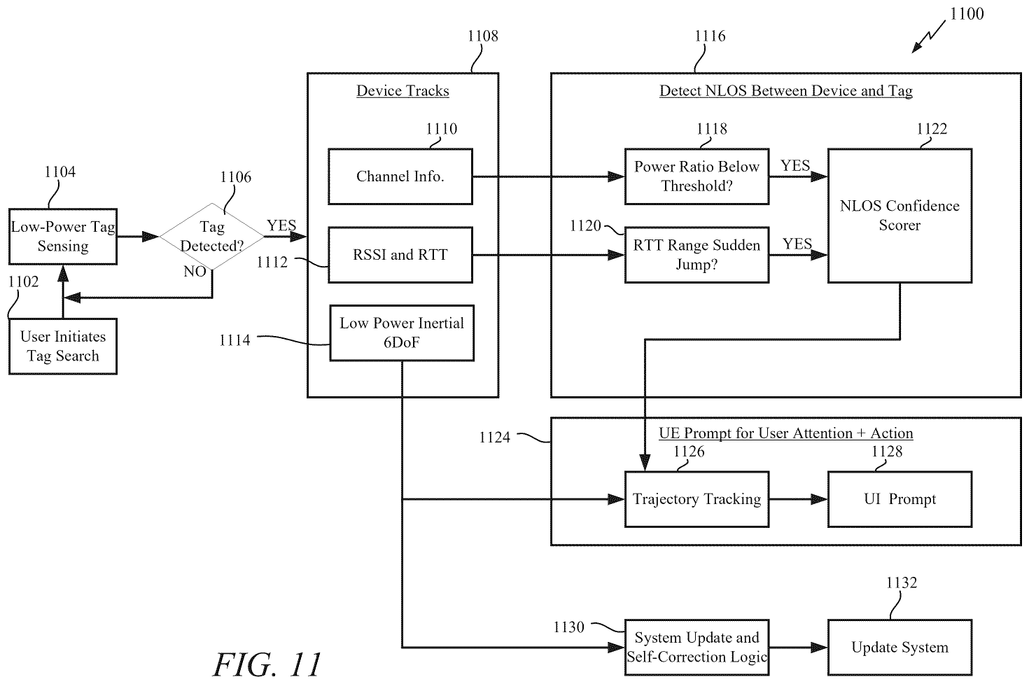

FIG. 11 illustrates an example implementation 1100 of the process 1000 of FIG. 10, in accordance with aspects of the disclosure. At 1102, the user initiates a tag search via a device. At 1104, the device performs low-power tag sensing. At 1106, the device determines whether a tag is detected. If not, the process returns to 1104. If so, the process advances to 1108 where the device tracks various information associated with the tag detection. In particular, the device tracks channel information (e.g., direct path signal, reflected path signal, etc.) at 1110, RSSI and RTT (e.g., signal strength, range or distance estimate, etc.) at 1112, and low power inertial 6DoF (e.g., trajectory of past few minutes, lines and turns, etc.) at 1114. At 1116, NLOS path detection between the device and the tag is performed. At 1118, the device determines whether a power ratio associated with the channel information (e.g., a power of a first group of CIR peaks divided by a total CIR power) is below a threshold. At 1120, the device tracks a trend comparison on RTT vs. RSSI by determining whether a RTT range change is above a threshold (i.e., sudden jump). At 1122, a NLOS confidence score determines a NLOS confidence score based on the outputs from 1118 and 1120, and provides the NLOS confidence score to a module 1124.

Referring to FIG. 11, at 1124, the device performs trajectory tracking based on the output from 1114 and 1122. For example, at 1124, the device may keep a log of a user's walking trajectory associated with NLOS detection, the device may determine user trajectory causing NLOS (e.g., NLOS since the last left turn), and/or the device may suggest a corrective movement (e.g., right turn). At 1128, the device outputs a UI prompt to the user (e.g., a LOS blockage alert, information of user traversed trajectory that led to the NLOS path, corrective movement suggestions, etc.).

Referring to FIG. 11, at 1130, the output from 1114 is used to implement system update and self-correction logic. For example, once user is prompted (e.g., turn right 90 degrees), detect user action, use it as measurement to self-correct 6DoF tracker logic, the device may keep a log of past few minutes (e.g., RSSI, RTT, CIR, CFR, CIS, thresholds, NLOS decision, trajectory and NLOS fusion, etc.), when user finds a tag and reaches it, use success case to update CIR, CFR, CIS, RTT thresholds for LOS vs NLOS cases, update user prompting logic if any previous prompt was unnecessary/erroneous, and so on. At 1132, the device updates the system (e.g., update the 6DoF tracker from known user motion measurement, CIR and/or CFR and/or CIS and/or RTT thresholds, user prompting, etc.).

Referring to FIG. 10, in a specific example, low-power IMU 6DoF tracking may be utilized to track user device trajectory (e.g., position, orientation). In an aspect, elementary trajectory detection (e.g., lines and turns) may also suffice. In an aspect, the user is prompted with corrective action (e.g., to turn around or move device in specific motion to calibrate ranging better). In an aspect, a camera need not be utilized (e.g., preserves privacy and keeps power consumption low).

Referring to FIG. 10, in a specific example, one way to identify LOS vs. NLOS is to look at channel information. In an aspect, channel impulse response (CIR) contains the channel information of the direct path signal as well as the channel information of the reflected paths signal. In an aspect, in LOS channel, the direct path signal occupies higher power percentage of the total signal power compared to NLOS channel. This can be used to identify LOS vs. NLOS. For example, one can detect a first peak in CIR and calculate the power percentage of the first peak over the total CIR power. If the percentage is higher than a threshold, the channel is identified as LOS. Alternatively, instead of using a first peak, one can detect a first group of peaks, and use the power percentage of the first group of peaks over the total CIR power to identify LOS vs. NLOS.

There are many applications where the direction to an object (tag) needs to be estimated using a phone (e.g., find lost items including a wireless transceiver (tag), find friends (phone to phone positioning), etc.). In an aspect, measurements from wireless technologies such as Wi-Fi, UWB and BLE can be fused with displacement estimates from sensor measurements to provide direction estimates. Example of sensors used for displacement estimate include Inertial Measurement Units (IMU) and camera. A benefit of this approach is that it does not rely on multiple antennas, for direction finding, and can be carried out using a single antenna, and limitation(s) of multi-antenna schemes due to calibration are avoided.

Large errors in the ranging estimates can be observed due to NLOS situations, where the LOS path from the tag to the phone is blocked. In an aspect, range estimate is obtained from Round Trip Time (RTT) measurements of dedicated WiFi/UWB/BLE signals. In some designs, outlier range estimates are observed frequently. This is typically observed regardless of the Wireless technology used for range estimates, and mostly due to physical limitations of first arrival path estimation. Generally, inertial sensor measurements such as IMU and camera can provide reliable and accurate measurements of the phone's position, and its relative displacement.

Further aspects of the disclosure are directed to round trip time (RTT) correction (e.g., based on a non-linear combination of multiple RTT measurements and/or an estimated displacement). Such aspects may provide various technical advantages, such as improved ranging/positioning, reduced ranging/positioning latency, reduced power consumption, etc.

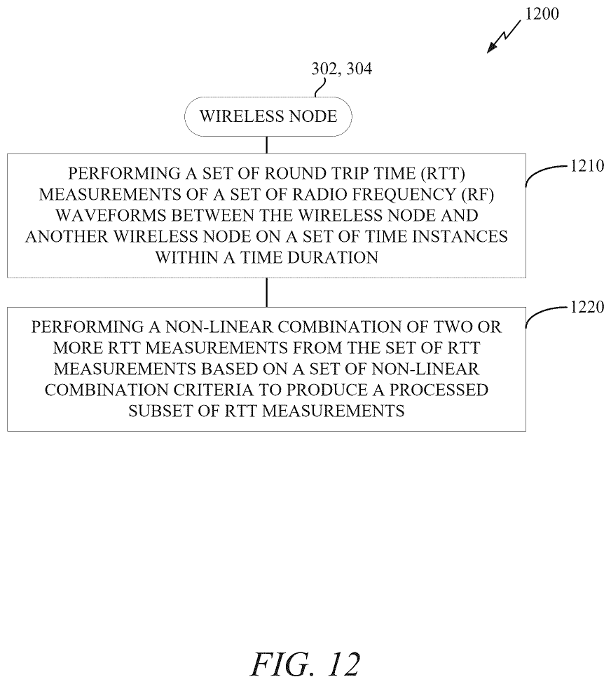

FIG. 12 illustrates an exemplary process 1200 of communications according to an aspect of the disclosure. The process 1200 of FIG. 12 is performed by a wireless node, such as UE 302 or a wireless network component such as gNB/BS 304 or O-RAN component such as RU.

Referring to FIG. 12, at 1210, the wireless node (e.g., processor(s) 342 or 384, positioning/ranging component 348 or 388, receiver 312 or 322 or 352 or 362, transmitter 314 or 324 or 354 or 364, etc.) performs a set of round trip time (RTT) measurements of a set of radio frequency (RF) waveforms between the wireless node and another wireless node on a set of time instances within a time duration. In some designs, a means for performing the RTT measurement(s) of 1210 includes processor(s) 342 or 384, positioning/ranging component 348 or 388, receiver 312 or 322 or 352 or 362, transmitter 314 or 324 or 354 or 364, etc., of FIGS. 3A-3B.

Referring to FIG. 12, at 1220, the wireless node (e.g., processor(s) 342 or 384, positioning/ranging component 348 or 388, etc.) performs a non-linear combination of two or more RTT measurements from the set of RTT measurements based on a set of non-linear combination criteria to produce a processed subset of RTT measurements. In some designs, a means for performing the non-linear combination of 1220 includes processor(s) 342 or 384, positioning/ranging component 348 or 388, etc., of FIGS. 3A-3B.

Referring to FIG. 12, in some designs, the non-linear combination includes replacing each RTT measurement of the set of RTT measurements with a reference RTT measurement value to produce the processed subset of RTT measurements. In an aspect, the reference RTT measurement value is a k-th smallest RTT measurement value within the time duration.

Referring to FIG. 12, in some designs, the wireless node further identifies a RTT measurement of the set of RTT measurements that is associated with a highest received signal strength. In an aspect, the non-linear combination comprises replacing, from the set of RTT measurements, each RTT measurement with the identified RTT measurement to produce the processed subset of RTT measurements.

Referring to FIG. 12, in some designs, the wireless node further estimates a displacement of the wireless node between a first time and a second time based on one or more sensor measurements. In an aspect, the set of non-linear combination criteria comprises the estimated displacement. In an aspect, the estimated displacement of the wireless node during a window of consecutive measurement instances is less than a first threshold, and the non-linear combination comprises replacing, in the set of RTT measurements within the time duration, each RTT measurement with a reference measurement value to produce the processed subset of RTT measurements. In an aspect, the reference RTT measurement value is a k-th smallest RTT measurement value within the time duration. In an aspect, k is an integer greater than or equal to 1, and no greater than the number of RTT measurement values within the time duration.

Referring to FIG. 12, in a specific example, the wireless node may perform percentile filtering for outlier for removal and bias reduction, e.g.:
Option 1: Take the T % lower percentile of the measurements within the window of length w as an improved RTT estimate. Move the window by stride length S across the measurements, and repeat, e.g.:

$$R T {T}_{v e c} = R T T ( n - \frac{W}{2} : n + \frac{W}{2} ) \to Y ( n ) = p r c t i l e ( RTT\_vec , T )$$

Option 2: Take the RTT with the highest received power (RSSI) value within the window of length w. Move the window by stride length S across the measurements, and repeat.

In an aspect, Option 1 and/or Option 2 help in error reduction due to NLOS conditions and/or undesired hardware bias.

Referring to FIG. 12, in a specific example, the wireless node may perform static portion detection based on sensor measurements. For example, group the nearby samples within Y (small motion, for example 10 cm), and pick the T % lower percentile value of the measurements. This groups the static samples and for joint processing→Z(n). In an aspect, measurements corresponding to a static position of the user (phone) can be combined to reduce the range estimation error.

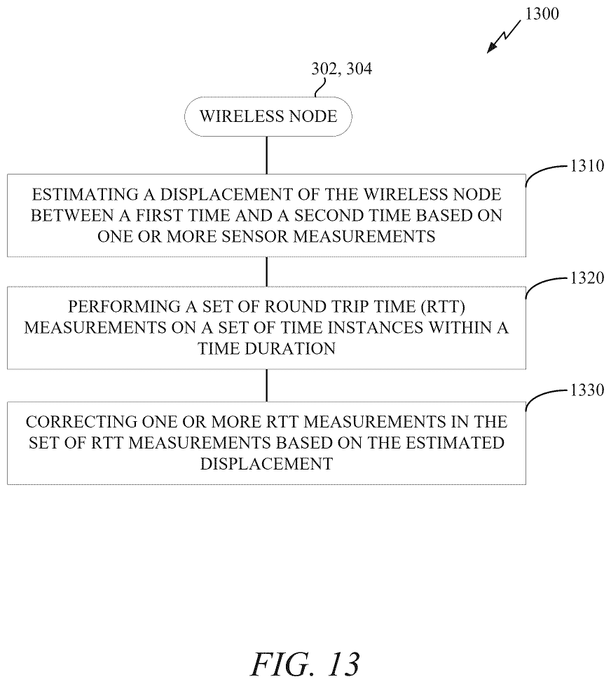

FIG. 13 illustrates an exemplary process 1300 of communications according to an aspect of the disclosure. The process 1300 of FIG. 13 is performed by a wireless node, such as UE 302 or a wireless network component such as gNB/BS 304 or O-RAN component such as RU.

Referring to FIG. 13, at 1310, the wireless node (e.g., sensor(s) 344, processor(s) 342 or 384, positioning/ranging component 348 or 388, etc.) estimates a displacement of the wireless node between a first time and a second time based on one or more sensor measurements. In some designs, a means for performing the estimation of 1310 includes sensor(s) 344, processor(s) 342 or 384, positioning/ranging component 348 or 388, etc., of FIGS. 3A-3B.

Referring to FIG. 13, at 1320, the wireless node (e.g., processor(s) 342 or 384, positioning/ranging component 348 or 388, receiver 312 or 322 or 352 or 362, transmitter 314 or 324 or 354 or 364, etc.) performs a set of round trip time (RTT) measurements on a set of time instances within a time duration (e.g., the time duration spanning from the first time to the second time). In some designs, a means for performing the RTT measurement(s) of 1320 includes processor(s) 342 or 384, positioning/ranging component 348 or 388, receiver 312 or 322 or 352 or 362, transmitter 314 or 324 or 354 or 364, etc., of FIGS. 3A-3B.

Referring to FIG. 13, at 1330, the wireless node (e.g., processor(s) 342 or 384, positioning/ranging component 348 or 388, etc.) corrects one or more RTT measurements in the set of RTT measurements based on the estimated displacement. In some designs, a means for performing the RTT measurement correction of 1330 includes processor(s) 342 or 384, positioning/ranging component 348 or 388, etc., of FIGS. 3A-3B.

Referring to FIG. 13, in some designs, the estimated displacement of the wireless node is less than a first threshold. In an aspect, the correction of 1330 includes processing the one or more RTT measurements from the set of RTT measurements by replacing, in the set of RTT measurements, each RTT measurement that indicates RTT measurement of more than a second threshold, with a value of the RTT measurement at the first time plus the displacement, scaled by a constant, to produce a processed subset of RTT measurements.

Referring to FIG. 13, in some designs, the correction of 1330 of the one or more RTT measurements is associated with a maximum RTT change value relative to another RTT measurement associated with the first time. In an aspect, the maximum RTT change is based on the estimated wireless node displacement.

Referring to FIG. 13, in a specific example, bias reduction filtering is performed based on displacement estimates. In an aspect, for each element of Z(n), limit the max variation in RTT, based on displacement estimates, Δr_{dis}(n)=abs(P_{dis}(n)−P_{dis}(n−1)):

$$R ( n ) = min ( Z ( n ) , R ( n - 1 ) + Δ {r}_{d i s} ( n ) * S F )$$

In an aspect, the above-noted bias reduction filtering may help to reduce error due to NLOS conditions and/or hardware bias.

Referring to FIGS. 12-13, in a specific example, the processes 1200 and/or 1300 may also improve AoA-based positioning, in addition to ranging estimates.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of operating a wireless node, comprising: determining a non-line of sight (NLOS) path associated with a communications link of the wireless node; and transmitting or outputting a set of instructions to a user of the wireless node in response to the determination, the set of instructions configured to guide the user towards establishment or re-establishment of a line of sight (LOS) path for the communications link, wherein the set of instructions is based on trajectory information of the wireless node between a first time and a second time.

Clause 2. The method of clause 1, further comprising: deriving a first round trip time (RTT) value associated with a first time based on a first set of RTT measurements; and deriving a second RTT value associated with a second time based on a second set of RTT measurements, and wherein the determination of the NLOS path associated with the communications link is based on the information associated with the first RTT value and the second RTT value.

Clause 3. The method of clause 2, wherein the information comprises: a first differential between a first received signal strength associated with the first set of RTT measurements and a second received signal strength associated with the second set of RTT measurements, or a second differential between a first ranging estimate based on the first RTT value and a second ranging estimate based on the second RTT value, or a combination thereof.

Clause 4. The method of any of clauses 1 to 3, further comprising: transmitting or outputting an NLOS alert to the user of the wireless node in response to the determination.

Clause 5. The method of any of clauses 1 to 4, wherein the trajectory information is based on sensor-based tracking of movement associated with the wireless node by one or more sensors.

Clause 6. The method of clause 5, wherein the sensor-based tracking is continuous, intermittent, or movement-triggered.

Clause 7. The method of any of clauses 5 to 6, wherein the sensor-based tracking is based on a battery level associated with the wireless node.

Clause 8. The method of any of clauses 5 to 7, wherein the sensor-based tracking comprises six degrees of freedom (6DoF)-based tracking.

Clause 9. The method of any of clauses 5 to 8, wherein the one or more sensors comprise a camera, a Global Navigation Satellite System (GNSS) sensor, an Inertial Measurement Unit (IMU) sensor, a Light Detection and Ranging (LiDAR) sensor, a Time of Flight (ToF) sensor, a radio ranging sensor using wireless or radio transmission, or any combination thereof.

Clause 10. A method of operating a wireless node, comprising: performing a set of round trip time (RTT) measurements of a set of radio frequency (RF) waveforms between the wireless node and another wireless node on a set of time instances within a time duration; and performing a non-linear combination of two or more RTT measurements from the set of RTT measurements based on a set of non-linear combination criteria to produce a processed subset of RTT measurements.

Clause 11. The method of clause 10, wherein the non-linear combination comprises: replacing each RTT measurement of the set of RTT measurements with a reference RTT measurement value to produce the processed subset of RTT measurements.

Clause 12. The method of clause 11, wherein the reference RTT measurement value is a k-th smallest RTT measurement value within the time duration.

Clause 13. The method of any of clauses 10 to 12, further comprising: identifying a RTT measurement of the set of RTT measurements that is associated with a highest received signal strength, wherein the non-linear combination comprises replacing, from the set of RTT measurements, each RTT measurement with the identified RTT measurement to produce the processed subset of RTT measurements.

Clause 14. The method of any of clauses 10 to 13, further comprising: estimating a displacement of the wireless node between a first time and a second time based on one or more sensor measurements, wherein the set of non-linear combination criteria comprises the estimated displacement.

Clause 15. The method of clause 14, wherein the estimated displacement of the wireless node during a time duration of consecutive measurement instances is less than a first threshold, and wherein the non-linear combination comprises replacing, in the set of RTT measurements within the time duration, each RTT measurement with a reference measurement value to produce the processed subset of RTT measurements.

Clause 16. The method of clause 15, wherein the reference RTT measurement value is a k-th smallest RTT measurement value within the time duration.

Clause 17. A method of operating a wireless node, comprising: estimating a displacement of the wireless node between a first time and a second time based on one or more sensor measurements; performing a set of round trip time (RTT) measurements on a set of time instances within a time duration; and correcting one or more RTT measurements in the set of RTT measurements based on the estimated displacement.

Clause 18. The method of clause 17, wherein the estimated displacement of the wireless node is less than a first threshold, wherein the correcting comprises: processing the one or more RTT measurements from the set of RTT measurements by replacing, in the set of RTT measurements, each RTT measurement that indicates RTT measurement of more than a second threshold, with a value of the RTT measurement at the first time plus the displacement scaled by a constant, to produce a processed subset of RTT measurements.

Clause 19. The method of any of clauses 17 to 18, wherein the correcting of the one or more RTT measurements is associated with a maximum RTT change value relative to another RTT measurement associated with the first time.

Clause 20. The method of clause 19, wherein the maximum RTT change is based on the estimated wireless node displacement.

Clause 21. A wireless node, comprising: one or more memories; one or more transceivers; and one or more processors communicatively coupled to the one or more memories and the one or more transceivers, the one or more processors, either alone or in combination, configured to: determine a non-line of sight (NLOS) path associated with a communications link of the wireless node; and transmit, via the one or more transceivers, or outputting a set of instructions to a user of the wireless node in response to the determination, the set of instructions configured to guide the user towards establishment or re-establishment of a line of sight (LOS) path for the communications link, wherein the set of instructions is based on trajectory information of the wireless node between a first time and a second time.

Clause 22. The wireless node of clause 21, wherein the one or more processors, either alone or in combination, are further configured to: derive a first round trip time (RTT) value associated with a first time based on a first set of RTT measurements; and derive a second RTT value associated with a second time based on a second set of RTT measurements, and wherein the determination of the NLOS path associated with the communications link is based on the information associated with the first RTT value and the second RTT value.

Clause 23. The wireless node of clause 22, wherein the information comprises: a first differential between a first received signal strength associated with the first set of RTT measurements and a second received signal strength associated with the second set of RTT measurements, or a second differential between a first ranging estimate based on the first RTT value and a second ranging estimate based on the second RTT value, or a combination thereof.

Clause 24. The wireless node of any of clauses 21 to 23, wherein the one or more processors, either alone or in combination, are further configured to: transmit, via the one or more transceivers, or outputting an NLOS alert to the user of the wireless node in response to the determination.

Clause 25. The wireless node of any of clauses 21 to 24, wherein the trajectory information is based on sensor-based tracking of movement associated with the wireless node by one or more sensors.

Clause 26. The wireless node of clause 25, wherein the sensor-based tracking is continuous, intermittent, or movement-triggered.

Clause 27. The wireless node of any of clauses 25 to 26, wherein the sensor-based tracking is based on a battery level associated with the wireless node.

Clause 28. The wireless node of any of clauses 25 to 27, wherein the sensor-based tracking comprises six degrees of freedom (6DoF)-based tracking.

Clause 29. The wireless node of any of clauses 25 to 28, wherein the one or more sensors comprise a camera, a Global Navigation Satellite System (GNSS) sensor, an Inertial Measurement Unit (IMU) sensor, a Light Detection and Ranging (LiDAR) sensor, a Time of Flight (ToF) sensor, a radio ranging sensor using wireless or radio transmission, or any combination thereof.

Clause 30. A wireless node, comprising: one or more memories; one or more transceivers; and one or more processors communicatively coupled to the one or more memories and the one or more transceivers, the one or more processors, either alone or in combination, configured to: perform a set of round trip time (RTT) measurements of a set of radio frequency (RF) waveforms between the wireless node and another wireless node on a set of time instances within a time duration; and perform a non-linear combination of two or more RTT measurements from the set of RTT measurements based on a set of non-linear combination criteria to produce a processed subset of RTT measurements.

Clause 31. The wireless node of clause 30, wherein the non-linear combination comprises: replace each RTT measurement of the set of RTT measurements with a reference RTT measurement value to produce the processed subset of RTT measurements.

Clause 32. The wireless node of clause 31, wherein the reference RTT measurement value is a k-th smallest RTT measurement value within the time duration.

Clause 33. The wireless node of any of clauses 30 to 32, wherein the one or more processors, either alone or in combination, are further configured to: identify a RTT measurement of the set of RTT measurements that is associated with a highest received signal strength, wherein the non-linear combination comprises replacing, from the set of RTT measurements, each RTT measurement with the identified RTT measurement to produce the processed subset of RTT measurements.

Clause 34. The wireless node of any of clauses 30 to 33, wherein the one or more processors, either alone or in combination, are further configured to: estimate a displacement of the wireless node between a first time and a second time based on one or more sensor measurements, wherein the set of non-linear combination criteria comprises the estimated displacement.

Clause 35. The wireless node of clause 34, wherein the estimated displacement of the wireless node during a time duration of consecutive measurement instances is less than a first threshold, and wherein the non-linear combination comprises replacing, in the set of RTT measurements within the time duration, each RTT measurement with a reference measurement value to produce the processed subset of RTT measurements.

Clause 36. The wireless node of clause 35, wherein the reference RTT measurement value is a k-th smallest RTT measurement value within the time duration.

Clause 37. A wireless node, comprising: one or more memories; one or more transceivers; and one or more processors communicatively coupled to the one or more memories and the one or more transceivers, the one or more processors, either alone or in combination, configured to: estimate a displacement of the wireless node between a first time and a second time based on one or more sensor measurements; perform a set of round trip time (RTT) measurements on a set of time instances within a time duration; and correct one or more RTT measurements in the set of RTT measurements based on the estimated displacement.

Clause 38. The wireless node of clause 37, wherein the estimated displacement of the wireless node is less than a first threshold, wherein the correcting comprises: process the one or more RTT measurements from the set of RTT measurements by replacing, in the set of RTT measurements, each RTT measurement that indicates RTT measurement of more than a second threshold, with a value of the RTT measurement at the first time plus the displacement scaled by a constant, to produce a processed subset of RTT measurements.

Clause 39. The wireless node of any of clauses 37 to 38, wherein the correcting of the one or more RTT measurements is associated with a maximum RTT change value relative to another RTT measurement associated with the first time.

Clause 40. The wireless node of clause 39, wherein the maximum RTT change is based on the estimated wireless node displacement.

Clause 41. A wireless node, comprising: means for determining a non-line of sight (NLOS) path associated with a communications link of the wireless node; and means for transmitting or outputting a set of instructions to a user of the wireless node in response to the determination, the set of instructions configured to guide the user towards establishment or re-establishment of a line of sight (LOS) path for the communications link, wherein the set of instructions is based on trajectory information of the wireless node between a first time and a second time.

Clause 42. The wireless node of clause 41, further comprising: means for deriving a first round trip time (RTT) value associated with a first time based on a first set of RTT measurements; and means for deriving a second RTT value associated with a second time based on a second set of RTT measurements, and wherein the determination of the NLOS path associated with the communications link is based on the information associated with the first RTT value and the second RTT value.

Clause 43. The wireless node of clause 42, wherein the information comprises: a first differential between a first received signal strength associated with the first set of RTT measurements and a second received signal strength associated with the second set of RTT measurements, or a second differential between a first ranging estimate based on the first RTT value and a second ranging estimate based on the second RTT value, or a combination thereof.

Clause 44. The wireless node of any of clauses 41 to 43, further comprising: means for transmitting or outputting an NLOS alert to the user of the wireless node in response to the determination.

Clause 45. The wireless node of any of clauses 41 to 44, wherein the trajectory information is based on sensor-based tracking of movement associated with the wireless node by one or more sensors.

Clause 46. The wireless node of clause 45, wherein the sensor-based tracking is continuous, intermittent, or movement-triggered.

Clause 47. The wireless node of any of clauses 45 to 46, wherein the sensor-based tracking is based on a battery level associated with the wireless node.

Clause 48. The wireless node of any of clauses 45 to 47, wherein the sensor-based tracking comprises six degrees of freedom (6DoF)-based tracking.

Clause 49. The wireless node of any of clauses 45 to 48, wherein the one or more sensors comprise a camera, a Global Navigation Satellite System (GNSS) sensor, an Inertial Measurement Unit (IMU) sensor, a Light Detection and Ranging (LiDAR) sensor, a Time of Flight (ToF) sensor, a radio ranging sensor using wireless or radio transmission, or any combination thereof.

Clause 50. A wireless node, comprising: means for performing a set of round trip time (RTT) measurements of a set of radio frequency (RF) waveforms between the wireless node and another wireless node on a set of time instances within a time duration; and means for performing a non-linear combination of two or more RTT measurements from the set of RTT measurements based on a set of non-linear combination criteria to produce a processed subset of RTT measurements.

Clause 51. The wireless node of clause 50, wherein the non-linear combination comprises: means for replacing each RTT measurement of the set of RTT measurements with a reference RTT measurement value to produce the processed subset of RTT measurements.

Clause 52. The wireless node of clause 51, wherein the reference RTT measurement value is a k-th smallest RTT measurement value within the time duration.

Clause 53. The wireless node of any of clauses 50 to 52, further comprising: means for identifying a RTT measurement of the set of RTT measurements that is associated with a highest received signal strength, wherein the non-linear combination comprises replacing, from the set of RTT measurements, each RTT measurement with the identified RTT measurement to produce the processed subset of RTT measurements.

Clause 54. The wireless node of any of clauses 50 to 53, further comprising: means for estimating a displacement of the wireless node between a first time and a second time based on one or more sensor measurements, wherein the set of non-linear combination criteria comprises the estimated displacement.

Clause 55. The wireless node of clause 54, wherein the estimated displacement of the wireless node during a time duration of consecutive measurement instances is less than a first threshold, and wherein the non-linear combination comprises replacing, in the set of RTT measurements within the time duration, each RTT measurement with a reference measurement value to produce the processed subset of RTT measurements.

Clause 56. The wireless node of clause 55, wherein the reference RTT measurement value is a k-th smallest RTT measurement value within the time duration.

Clause 57. A wireless node, comprising: means for estimating a displacement of the wireless node between a first time and a second time based on one or more sensor measurements; means for performing a set of round trip time (RTT) measurements on a set of time instances within a time duration; and means for correcting one or more RTT measurements in the set of RTT measurements based on the estimated displacement.

Clause 58. The wireless node of clause 57, wherein the estimated displacement of the wireless node is less than a first threshold, wherein the correcting comprises: means for processing the one or more RTT measurements from the set of RTT measurements by replacing, in the set of RTT measurements, each RTT measurement that indicates RTT measurement of more than a second threshold, with a value of the RTT measurement at the first time plus the displacement scaled by a constant, to produce a processed subset of RTT measurements.

Clause 59. The wireless node of any of clauses 57 to 58, wherein the correcting of the one or more RTT measurements is associated with a maximum RTT change value relative to another RTT measurement associated with the first time.

Clause 60. The wireless node of clause 59, wherein the maximum RTT change is based on the estimated wireless node displacement.

Clause 61. A non-transitory computer-readable medium storing computer-executable instructions that, when executed by a wireless node, cause the wireless node to: determine a non-line of sight (NLOS) path associated with a communications link of the wireless node; and transmit or outputting a set of instructions to a user of the wireless node in response to the determination, the set of instructions configured to guide the user towards establishment or re-establishment of a line of sight (LOS) path for the communications link, wherein the set of instructions is based on trajectory information of the wireless node between a first time and a second time.

Clause 62. The non-transitory computer-readable medium of clause 61, further comprising computer-executable instructions that, when executed by the wireless node, cause the wireless node to: derive a first round trip time (RTT) value associated with a first time based on a first set of RTT measurements; and derive a second RTT value associated with a second time based on a second set of RTT measurements, and wherein the determination of the NLOS path associated with the communications link is based on the information associated with the first RTT value and the second RTT value.

Clause 63. The non-transitory computer-readable medium of clause 62, wherein the information comprises: a first differential between a first received signal strength associated with the first set of RTT measurements and a second received signal strength associated with the second set of RTT measurements, or a second differential between a first ranging estimate based on the first RTT value and a second ranging estimate based on the second RTT value, or a combination thereof.

Clause 64. The non-transitory computer-readable medium of any of clauses 61 to 63, further comprising computer-executable instructions that, when executed by the wireless node, cause the wireless node to: transmit or outputting an NLOS alert to the user of the wireless node in response to the determination.

Clause 65. The non-transitory computer-readable medium of any of clauses 61 to 64, wherein the trajectory information is based on sensor-based tracking of movement associated with the wireless node by one or more sensors.

Clause 66. The non-transitory computer-readable medium of clause 65, wherein the sensor-based tracking is continuous, intermittent, or movement-triggered.

Clause 67. The non-transitory computer-readable medium of any of clauses 65 to 66, wherein the sensor-based tracking is based on a battery level associated with the wireless node.

Clause 68. The non-transitory computer-readable medium of any of clauses 65 to 67, wherein the sensor-based tracking comprises six degrees of freedom (6DoF)-based tracking.

Clause 69. The non-transitory computer-readable medium of any of clauses 65 to 68, wherein the one or more sensors comprise a camera, a Global Navigation Satellite System (GNSS) sensor, an Inertial Measurement Unit (IMU) sensor, a Light Detection and Ranging (LiDAR) sensor, a Time of Flight (ToF) sensor, a radio ranging sensor using wireless or radio transmission, or any combination thereof.

Clause 70. A non-transitory computer-readable medium storing computer-executable instructions that, when executed by a wireless node, cause the wireless node to: perform a set of round trip time (RTT) measurements of a set of radio frequency (RF) waveforms between the wireless node and another wireless node on a set of time instances within a time duration; and perform a non-linear combination of two or more RTT measurements from the set of RTT measurements based on a set of non-linear combination criteria to produce a processed subset of RTT measurements.

Clause 71. The non-transitory computer-readable medium of clause 70, wherein the non-linear combination comprises: replace each RTT measurement of the set of RTT measurements with a reference RTT measurement value to produce the processed subset of RTT measurements.

Clause 72. The non-transitory computer-readable medium of clause 71, wherein the reference RTT measurement value is a k-th smallest RTT measurement value within the time duration.

Clause 73. The non-transitory computer-readable medium of any of clauses 70 to 72, further comprising computer-executable instructions that, when executed by the wireless node, cause the wireless node to: identify a RTT measurement of the set of RTT measurements that is associated with a highest received signal strength, wherein the non-linear combination comprises replacing, from the set of RTT measurements, each RTT measurement with the identified RTT measurement to produce the processed subset of RTT measurements.

Clause 74. The non-transitory computer-readable medium of any of clauses 70 to 73, further comprising computer-executable instructions that, when executed by the wireless node, cause the wireless node to: estimate a displacement of the wireless node between a first time and a second time based on one or more sensor measurements, wherein the set of non-linear combination criteria comprises the estimated displacement.

Clause 75. The non-transitory computer-readable medium of clause 74, wherein the estimated displacement of the wireless node during a time duration of consecutive measurement instances is less than a first threshold, and wherein the non-linear combination comprises replacing, in the set of RTT measurements within the time duration, each RTT measurement with a reference measurement value to produce the processed subset of RTT measurements.

Clause 76. The non-transitory computer-readable medium of clause 75, wherein the reference RTT measurement value is a k-th smallest RTT measurement value within the time duration.

Clause 77. A non-transitory computer-readable medium storing computer-executable instructions that, when executed by a wireless node, cause the wireless node to: estimate a displacement of the wireless node between a first time and a second time based on one or more sensor measurements; perform a set of round trip time (RTT) measurements on a set of time instances within a time duration; and correct one or more RTT measurements in the set of RTT measurements based on the estimated displacement.

Clause 78. The non-transitory computer-readable medium of clause 77, wherein the estimated displacement of the wireless node is less than a first threshold, wherein the correcting comprises: process the one or more RTT measurements from the set of RTT measurements by replacing, in the set of RTT measurements, each RTT measurement that indicates RTT measurement of more than a second threshold, with a value of the RTT measurement at the first time plus the displacement scaled by a constant, to produce a processed subset of RTT measurements.

Clause 79. The non-transitory computer-readable medium of any of clauses 77 to 78, wherein the correcting of the one or more RTT measurements is associated with a maximum RTT change value relative to another RTT measurement associated with the first time.

Clause 80. The non-transitory computer-readable medium of clause 79, wherein the maximum RTT change is based on the estimated wireless node displacement.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A wireless node, comprising:
one or more memories;
one or more transceivers; and
one or more processors communicatively coupled to the one or more memories and the one or more transceivers, the one or more processors, either alone or in combination, configured to:
determine a non-line of sight (NLOS) path associated with a communications link of the wireless node; and
transmit, via the one or more transceivers, or outputting a set of instructions to a user of the wireless node in response to the determination, the set of instructions configured to guide the user towards establishment or re-establishment of a line of sight (LOS) path for the communications link,
wherein the set of instructions is based on trajectory information of the wireless node between a first time and a second time.

2. The wireless node of claim 1, wherein the one or more processors, either alone or in combination, are further configured to:
derive a first round trip time (RTT) value associated with a first time based on a first set of RTT measurements; and
derive a second RTT value associated with a second time based on a second set of RTT measurements, and
wherein the determination of the NLOS path associated with the communications link is based on the information associated with the first RTT value and the second RTT value.

3. The wireless node of claim 2, wherein the information comprises:
a first differential between a first received signal strength associated with the first set of RTT measurements and a second received signal strength associated with the second set of RTT measurements, or
a second differential between a first ranging estimate based on the first RTT value and a second ranging estimate based on the second RTT value, or
a combination thereof.

4. The wireless node of claim 1, wherein the one or more processors, either alone or in combination, are further configured to:
transmit, via the one or more transceivers, or outputting an NLOS alert to the user of the wireless node in response to the determination.

5. The wireless node of claim 1, wherein the trajectory information is based on sensor-based tracking of movement associated with the wireless node by one or more sensors.

6. The wireless node of claim 5, wherein the sensor-based tracking is continuous, intermittent, or movement-triggered.

7. The wireless node of claim 5, wherein the sensor-based tracking is based on a battery level associated with the wireless node.

8. The wireless node of claim 5, wherein the sensor-based tracking comprises six degrees of freedom (6DoF)-based tracking.

9. The wireless node of claim 5, wherein the one or more sensors comprise a camera, a Global Navigation Satellite System (GNSS) sensor, an Inertial Measurement Unit (IMU) sensor, a Light Detection and Ranging (LiDAR) sensor, a Time of Flight (ToF) sensor, a radio ranging sensor using wireless or radio transmission, or any combination thereof.

10. A wireless node, comprising:
one or more memories;
one or more transceivers; and
one or more processors communicatively coupled to the one or more memories and the one or more transceivers, the one or more processors, either alone or in combination, configured to:
perform a set of round trip time (RTT) measurements of a set of radio frequency (RF) waveforms between the wireless node and another wireless node on a set of time instances within a time duration; and
perform a non-linear combination of two or more RTT measurements from the set of RTT measurements based on a set of non-linear combination criteria to produce a processed subset of RTT measurements.

11. The wireless node of claim 10, wherein the non-linear combination comprises:
replace each RTT measurement of the set of RTT measurements with a reference RTT measurement value to produce the processed subset of RTT measurements.

12. The wireless node of claim 11, wherein the reference RTT measurement value is a k-th smallest RTT measurement value within the time duration.

13. The wireless node of claim 10, wherein the one or more processors, either alone or in combination, are further configured to:
identify a RTT measurement of the set of RTT measurements that is associated with a highest received signal strength,
wherein the non-linear combination comprises replacing, from the set of RTT measurements, each RTT measurement with the identified RTT measurement to produce the processed subset of RTT measurements.

14. The wireless node of claim 10, wherein the one or more processors, either alone or in combination, are further configured to:
estimate a displacement of the wireless node between a first time and a second time based on one or more sensor measurements,
wherein the set of non-linear combination criteria comprises the estimated displacement.

15. The wireless node of claim 14,
wherein the estimated displacement of the wireless node during a time duration of consecutive measurement instances is less than a first threshold, and
wherein the non-linear combination comprises replacing, in the set of RTT measurements within the time duration, each RTT measurement with a reference measurement value to produce the processed subset of RTT measurements.

16. The wireless node of claim 15, wherein the reference RTT measurement value is a k-th smallest RTT measurement value within the time duration.

17. A wireless node, comprising:
one or more memories;
one or more transceivers; and
one or more processors communicatively coupled to the one or more memories and the one or more transceivers, the one or more processors, either alone or in combination, configured to:
estimate a displacement of the wireless node between a first time and a second time based on one or more sensor measurements;
perform a set of round trip time (RTT) measurements on a set of time instances within a time duration; and
correct one or more RTT measurements in the set of RTT measurements based on the estimated displacement.

18. The wireless node of claim 17,
wherein the estimated displacement of the wireless node is less than a first threshold, wherein the correcting comprises:
process the one or more RTT measurements from the set of RTT measurements by replacing, in the set of RTT measurements, each RTT measurement that indicates RTT measurement of more than a second threshold, with a value of the RTT measurement at the first time plus the displacement scaled by a constant, to produce a processed subset of RTT measurements.

19. The wireless node of claim 17, wherein the correcting of the one or more RTT measurements is associated with a maximum RTT change value relative to another RTT measurement associated with the first time.

20. The wireless node of claim 19, wherein the maximum RTT change is based on the estimated wireless node displacement.
